(19) United States
(12) Patent Application Publication
(10) Pub. No.: US 2024/0126015 A1
(43) Pub. Date: Apr. 18, 2024

(54) OPTICAL COUPLER AND VISIBLE LIGHT SOURCE MODULE

(71) Applicant: TDK CORPORATION, Tokyo (JP)

(72) Inventors: Hajime UTSUNOMIYA, Tokyo (JP); Yasuhiro TAKAGI, Tokyo (JP); Hiroki HARA, Tokyo (JP); Atsushi SHIMURA, Tokyo (JP); Jiro YOSHINARI, Tokyo (JP); Takashi KIKUKAWA, Tokyo (JP); Tsuyoshi KOMAKI, Tokyo (JP); Hideaki FUKUZAWA, Tokyo (JP)

(73) Assignee: TDK CORPORATION, Tokyo (JP)

(21) Appl. No.: 18/377,602

(22) Filed: Oct. 6, 2023

(30) Foreign Application Priority Data
Oct. 14, 2022 (JP) 2022-165425

(51) Int. Cl. G02B 6/293

(52) U.S. Cl. CPC G02B 6/29344

(57) ABSTRACT

This optical coupler for coupling a plurality of visible light beams having different wavelengths includes: a substrate made of a material different from lithium niobate; and an optical coupling function layer formed on a main surface of the substrate. The optical coupling function layer includes: two multimode-interference-type optical coupling parts; optical-input-side waveguides and an optical-output-side waveguide connected to one multimode-interference-type optical coupling part, and optical-input-side waveguides and an optical-output-side waveguide connected to the other multimode-interference-type optical coupling part. The multimode-interference-type optical coupling parts, the optical-input-side waveguides, and the optical-output-side waveguides are made of a lithium niobate film.

### CROSS-REFERENCE TO RELATED APPLICATION

The present application claims priority on Japanese Patent Application No. 2022-165425 filed on Oct. 14, 2022, the content of which is incorporated herein by reference.

### BACKGROUND OF THE INVENTION

### Field of the Invention

The present invention relates to an optical coupler and a visible light source module.

### Description of Related Art

XR glasses such as augmented reality (AR) glasses and virtual reality (VR) glasses are expected to be small wearable devices. The key to widespread use of wearable devices such as AR glasses and VR glasses is to implement miniaturization so that each function fits within the size of ordinary eyeglasses.
In Patent Document 1, a retina-projection-type display using a Mach-Zehnder-type optical modulator is disclosed.

Although a plurality of optical waveguides are close to each other in an output part in the retina-projection-type display disclosed in Patent Document 1, an optical axis for each wavelength is different and the control of output light becomes complicated because a coupling process is not performed.
In Patent Document 2, a quartz-based planar lightwave circuit (PLC) including a directional coupler as a coupler of visible light of three colors of RGB (R: red light, G: green light, B: blue light) is disclosed. The quartz-based PLC is composed of a quartz-based material and has excellent stability. However, in the case where a lithium niobate (LiNbO₃) substrate having a large refractive index difference Δn is used, a coupling length becomes long and miniaturization is difficult.
In Patent Document 3 and Patent Document 4, a coupler of visible light of three RGB colors using a multimode interference (MMI) is disclosed. This coupler is also made of a quartz-based material and a case where a lithium niobate (LiNbO₃) substrate having a large refractive index difference Δn is used is not disclosed.

In Patent Document 1, a case where a single crystal or a solid solution crystal of lithium niobate is used and a portion obtained by modifying a part of the crystal by a proton exchange method or a Ti diffusion method is used as an optical waveguide is disclosed as a preferred aspect. However, because a size of the modified waveguide portion (core) region is determined by a distance to which protons and Ti have penetrated and diffused, it is difficult to reduce a diameter of the optical waveguide. For this reason, a size of the optical waveguide itself inevitably becomes large, it is difficult to concentrate an electric field of a modulation voltage due to the large diameter of the optical waveguide, and it is necessary to apply a large voltage for modulation or it is necessary to lengthen the electrode to which the voltage is applied to operate at a small voltage, and because of this, a size of a modulation element becomes large.

Furthermore, due to a large diameter of the optical waveguide, a high-order mode is generated when visible light propagates in the optical waveguide and the implementation of a single mode is difficult.

Also, as shown in FIG. 18(a), in a modulator in which a portion B1-a obtained by modifying a part of a single crystal B1 of bulk lithium niobate is used as an optical waveguide, a small amount of Ti is added to create a refractive index difference Δn in a single crystal of bulk lithium niobate; and therefore, the refractive index difference between the modified waveguide portion (core) and the unmodified portion (cladding) is small. Therefore, it is difficult to reduce a size of an element because the bending loss due to bending of the optical waveguide is large and an optical waveguide cannot be curved with high curvature. Although the modulation light source mounted on a head-mounted display such as AR glasses is required to have a size that fits within a size of eyeglass temples as an example, it is difficult to produce an optical modulator miniaturized to such a size in the bulk crystal type optical modulator as in Patent Document 2.

In the case where a protrusion portion Fridge obtained by processing a single-crystal lithium niobate film F epitaxially grown on a substrate of sapphire or the like, as shown in FIG. 18(b), serves as an optical waveguide with respect to a modulator in which a portion B1-a, which is a modified portion of lithium niobate single crystal B1, is used as an optical waveguide (for example, see Patent Document 5), it is suitable for miniaturization for the following reasons.
(1) First of all, this protrusion portion is smaller in size than the Ti diffusion optical waveguide.
(2) Because everything around the protrusion portion corresponds to cladding, the refractive index difference Δn can be increased by appropriately selecting the surrounding materials.
(3) The optical loss when the optical waveguide is bent in a curved shape is less than that of a single crystal of bulk lithium niobate.

### PATENT DOCUMENTS

[Patent Document 1] Japanese Patent No. 6728596
[Patent Document 2] Japanese Patent No. 6572377
[Patent Document 3] Japanese Unexamined Patent Application, First Publication No. 2012-48071
[Patent Document 4] Japanese Unexamined Patent Application, First Publication No. 2020-27170
[Patent Document 5] Japanese Patent No. 6787397

### SUMMARY OF THE INVENTION

The present invention has been made in view of the above-described problems and an objective of the present invention is to provide a small optical coupler and a visible light source module applicable to XR glasses and the like.

The present invention provides the following solutions to solve the above-described problems.
According to Aspect 1 of the present invention, there is provided an optical coupler for coupling a plurality of visible light beams having different wavelengths, the optical coupler including: a substrate made of a material different from lithium niobate; and an optical coupling function layer formed on a main surface of the substrate, wherein the optical coupling function layer includes one or more stages of multimode-interference-type optical coupling parts and optical-input-side waveguides and optical-output-side waveguides connected to the one or more stages of multimode-interference-type optical coupling parts, and wherein the multimode-interference-type optical coupling parts, the optical-input-side waveguides, and the optical-output-side waveguides are made of a lithium niobate film.
According to Aspect 2 of the present invention, there is provided a visible light source module including: the optical coupler according to Aspect 1; and a plurality of visible laser light sources configured to output visible light coupled by the optical coupler.
According to Aspect 3 of the present invention, there is provided an optical coupler with an optical modulation function including: the optical coupler according to Aspect 1; and a Mach-Zehnder-type optical modulator connected to the optical coupler and configured to guide a plurality of visible light beams output from a plurality of visible laser light sources to the optical coupler.
According to Aspect 4 of the present invention, there is provided a visible light source module including: the optical coupler with the optical modulation function according to Aspect 3; and a plurality of visible laser light sources configured to output visible light to be coupled by the optical coupler with the optical modulation function.

According to the aspects of the present invention, a small optical coupler applicable to XR glasses and the like can be provided.

### BRIEF DESCRIPTION OF THE DRAWINGS

FIG. 1 is a schematic plan view of an optical coupler according to a first embodiment.

FIG. 2 is a schematic cross-sectional view of the optical coupler according to the first embodiment along line X-X of FIG. 1.

FIG. 3A is a graph for comparing propagation losses of light of three RGB colors in the case where a cross-section of a multimode-interference-type optical coupling part is rectangular.

FIG. 3B is a graph for comparing propagation losses of light of the three RGB colors in the case where the cross-section of the multimode-interference-type optical coupling part is a trapezoidal shape.

FIG. 4A is a schematic plan view showing a model used in the simulation of FIG. 3B.

FIG. 4B is a schematic cross-sectional view along line A-A of FIG. 4A.

FIG. 5A is a schematic plan view showing a model used in the simulation of FIG. 3A.

FIG. 5B is a schematic cross-sectional view along line A-A of FIG. 5A.

FIG. 6 is a schematic cross-sectional view of a configuration in which a multimode-interference-type optical coupling part with a trapezoidal cross-section has a ridge and a slab portion further provided on a substrate side.

FIG. 7A is a schematic cross-sectional view of an optical waveguide made of a lithium niobate film formed on a sapphire substrate and is a view of a case where there is a slab portion.

FIG. 7B is a schematic cross-sectional view of an optical waveguide made of a lithium niobate film formed on a sapphire substrate and is a view of a case where there is no slab portion.

FIG. 8A is a matrix showing a result of investigating the formation of a single mode by performing mode calculation when a thickness T_{slab} of the slab portion and a width Wa of the ridge are changed and a result of a case of red light (R) 638 nm in the optical waveguide model shown in FIGS. 7A and 7B.

FIG. 8B is a matrix showing a result of investigating the formation of a single mode by performing mode calculation when a thickness T_{slab} of the slab portion and a width Wa of the ridge are changed and a result of a case of green light (G) 520 nm in the optical waveguide model shown in FIGS. 7A and 7B.

FIG. 8C is a matrix showing a result of investigating the formation of a single mode by performing mode calculation when a thickness T_{slab} of the slab portion and a width Wa of the ridge are changed and a result of a case of blue light (B) 455 nm in the optical waveguide model shown in FIGS. 7A and 7B.

FIG. 9 is a diagram showing a result of investigating the suppression of a high-order mode in the case where a bending portion is provided in a part of the optical waveguide, a result of a case of red light (R) 638 nm, and a result of a case of blue light (B) 455 nm.

FIG. 10 is a schematic plan view showing a configuration of an optical coupler of Comparative Example 1.

FIG. 11 is a diagram showing simulation results of propagation loss during coupling of Comparative Example 1.

FIG. 12 is a schematic plan view showing a configuration of an optical coupler of Example 1.

FIG. 13 is a diagram showing simulation results of propagation loss during coupling of Example 1.

FIG. 14 is a diagram showing simulation results of propagation loss during coupling of Example 2.

FIG. 15 is a diagram showing simulation results of Examples 1 to 6 and Comparative Examples 1 to 3.

FIG. 16 is a schematic plan view of a visible light source module according to the first embodiment.

FIG. 17 is a schematic plan view of a visible light source module according to a second embodiment.

FIG. 18(a) is a conceptual diagram for describing a modulator in which a portion obtained by modifying a part of a single crystal of bulk lithium niobate is an optical waveguide, and FIG. 18(b) is a conceptual diagram for describing a modulator in which a protrusion portion obtained by processing a single-crystal lithium niobate film is an optical waveguide.

### DETAILED DESCRIPTION OF THE INVENTION

Hereinafter, embodiments will be described in detail with reference to the drawings as appropriate. In the drawings used in the following description, featured parts may be enlarged for convenience such that the features of the present invention are easier to understand, and dimensional ratios and the like of the respective components may be different from actual ones. Materials, dimensions, and the like exemplified in the following description are examples, the present invention is not limited thereto, and modifications can be appropriately made in a range in which advantageous effects of the present invention are exhibited. Also, in the following description, “±a” indicates a range of −a to +a.

### [Optical Coupler]

### First Embodiment

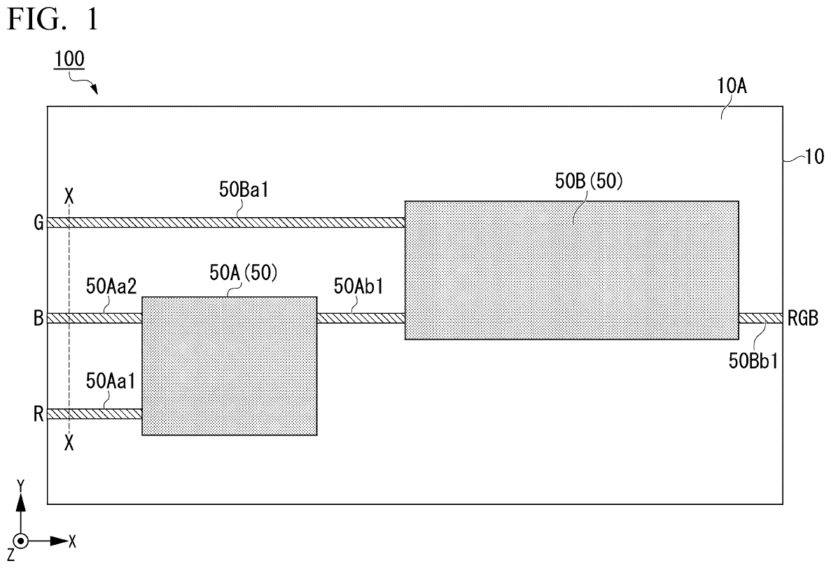

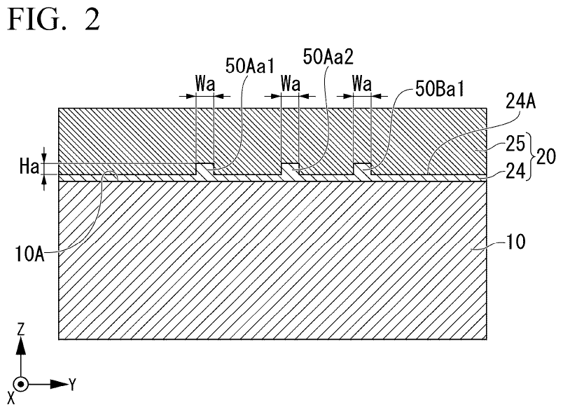

FIG. 1 is a schematic plan view of an optical coupler according to a first embodiment. FIG. 2 is a schematic cross-sectional view of the optical coupler according to the first embodiment along line X-X of FIG. 1.

An optical coupler 100 shown in FIG. 1 is an optical coupler for coupling a plurality of visible light beams having different wavelengths, the optical coupler includes: a substrate 10 made of a material different from lithium niobate; and an optical coupling function layer 20 formed on a main surface 10A of the substrate 10, wherein the optical coupling function layer 20 includes two multimode-interference-type optical coupling parts 50 (50A and 50B), optical-input-side waveguides 50Aa1 and 50Aa2 and an optical-output-side waveguide 50Ab1 which are connected to the multimode-interference-type optical coupling part 50A, and optical-input-side waveguides 50Ba1 and 50Ab1 and an optical-output-side waveguide 50Bb1 which are connected to the multimode-interference-type optical coupling part 50B, and wherein the multimode-interference-type optical coupling part 50, the optical-input-side waveguides 50Aa1 and 50Aa2, the optical-output-side waveguide 50Ab1, the optical-input-side waveguides 50Ba1 and 50Ab1, and the optical-output-side waveguide 50Bb1 are made of a lithium niobate film.

The optical-output-side waveguide 50Ab1 of the multimode-interference-type optical coupling part 50A and the optical-input-side waveguide 50Ab1 of the multimode-interference-type optical coupling part 50B are the same.

In the optical coupler 100, a radius of curvature of the optical waveguide can be reduced using a lithium niobate film having a large value of Δn and both the improvement of a degree of freedom of design and miniaturization can be achieved by preventing a coupling length from increasing by using a multimode-interference-type optical coupler as compared with the case where a directional coupler is used.

The optical coupling function layer 20 includes: a waveguide core film 24 formed of a lithium niobate film on which the multimode-interference-type optical coupler 50, the optical-input-side waveguides 50Aa1 and 50Aa2, the optical-output-side waveguide 50Ab1, the optical-input-side waveguides 50Ba1 and 50Ab1, and the optical-output-side waveguides 50Bb1 are formed; and a waveguide cladding (buffer) film 25 formed on the waveguide core film 24 to cover these. Hereinafter, reference numeral 24 may be used for the lithium niobate film.

Examples of the substrate 10 include a sapphire substrate, a Si substrate, a thermal silicon oxide substrate, and the like.

Although there is no particular limitation as long as the substrate has a lower refractive index than the lithium niobate film because the multimode-interference-type optical coupling part 50, the optical-input-side waveguides 50Aa1 and 50Aa2, the optical-output-side waveguide 50Ab1, the optical-input-side waveguides 50Ba1 and 50Ab1, and the optical-output-side waveguide 50Bb1 are formed of a lithium niobate (LiNbO₃) film, a sapphire single-crystal substrate or a silicon single-crystal substrate is preferred as a substrate on which a single-crystal lithium niobate film can be formed as an epitaxial film. Although the crystal orientation of the single-crystal substrate is not particularly limited, for example, because a c-axis-oriented lithium niobate film has 3-fold symmetry, it is preferable that an underlying single-crystal substrate also have the same symmetry and a substrate of a c-plane in the case of a sapphire single-crystal substrate or a substrate of a (111) plane in the case of a silicon single-crystal substrate is preferred.

The lithium niobate film is, for example, a c-axis-oriented lithium niobate film. The lithium niobate film is, for example, an epitaxial film epitaxially grown on the substrate 10. The epitaxial film is a single-crystal film in which the crystal orientation is aligned with the base substrate. The epitaxial film is a film having a single-crystal orientation in the z-direction and the xy-plane direction and all crystals are aligned and oriented along the x-axis, the y-axis, and the z-axis. It is possible to prove whether or not the film formed on the substrate 10 is an epitaxial film, for example, by confirming the peak intensity and the pole at the orientation position in 2 θ-θ X-ray diffraction.

Specifically, when measurement by 2 θ-θ X-ray diffraction is performed, all peak intensities other than that of the target surface are 10% or less, preferably 5% or less of the maximum peak intensity of the target surface. For example, in the case where the lithium niobate film is a c-axis oriented epitaxial film, the peak intensity other than that of the (00L) plane is 10% or less, preferably 5% or less of the maximum peak intensity of the (00L) plane. (00L) is an indication that collectively refers to equivalent surfaces such as (001) and (002).

Also, in the conditions for confirming the peak intensity at the above-described orientation position, only an orientation in one direction is shown. Therefore, even if the above-described conditions are obtained, when the crystal orientation is not aligned in the plane, the intensity of the X-rays does not increase at a specific angle position and the pole is not seen. For example, in the case of a lithium niobate film, because LiNbO₃ has a trigonal crystal structure, the number of poles of LiNbO₃ (014) in a single crystal becomes three.

In the case of lithium niobate, it is known that epitaxial growth occurs in a so-called twined crystal state in which crystals rotated 180° around the c-axis are symmetrically bonded. In this case, because the three poles are symmetrically joined by two, the number of poles is six. Also, in the case where a lithium niobate film is formed on a silicon single-crystal substrate on the (100) plane, because the substrate has four-fold symmetry, 4×3=12 poles are observed. Also, in the present disclosure, a lithium niobate film epitaxially grown in a twined crystal state is also included in the examples of the epitaxial film.

The composition of lithium niobate is LiₓNbA_{y}O_{z}. A is an element other than Li, Nb, and O. x is 0.5 or more and 1.2 or less, preferably 0.9 or more and 1.05 or less. y is 0 or more and 0.5 or less. z is 1.5 or more and 4.0 or less, preferably 2.5 or more and 3.5 or less. The element A is, for example, K, Na, Rb, Cs, Be, Mg, Ca, Sr, Ba, Ti, Zr, Hf, V, Cr, Mo, W, Fe, Co, Ni, Zn, Sc, or Ce, and two or more of these elements may be combined.

Furthermore, the lithium niobate film may be a thin lithium niobate single-crystal film bonded on a substrate.

A thickness of the lithium niobate film is, for example, 2 μm or less. The thickness of the lithium niobate film is a film thickness of a portion other than a ridge portion. It is only necessary to appropriately design the thickness of the lithium niobate film in accordance with a wavelength to be used, a ridge shape, or the like.

The optical-input-side waveguides 50Aa1 and 50Aa2, the optical-output-side waveguide 50Ab1, the optical-input-side waveguides 50Ba1 and 50Ab1, and the optical-output-side waveguide 50Bb1 are passageways through which light propagates inside. The optical-input-side waveguides 50Aa1 and 50Aa2, the optical-output-side waveguide 50Ab1, the optical-input-side waveguides 50Ba1 and 50Ab1, and the optical-output-side waveguide 50Bb1 are ridges protruding from the first surface 24A of the lithium niobate film 24. The first surface 24A is an upper surface in a portion (slab layer) other than the ridge portion of the lithium niobate film 24. The lithium niobate film 24 includes the multimode-interference-type optical coupling part 50, the optical-input-side waveguides 50Aa1 and 50Aa2, the optical-output-side waveguide 50Ab1, the optical-input-side waveguides 50Ba1 and 50Ab1, the optical-output-side waveguide 50Bb1, and the slab layer.

A cross-sectional shape of the cross-sectional shape formation part of the optical-input-side waveguides 50Aa1 and 50Aa2, the optical-output-side waveguide 50Ab1, the optical-input-side waveguides 50Ba1 and 50Ab1, and the optical-output-side waveguide 50Bb1 shown in FIG. 2 is rectangular, but may be any shape as long as it can guide light. For example, it may be a trapezoidal shape, a triangular shape, a semicircular shape, or the like. Widths Wa of the three ridges in the y-direction are preferably 0.2 μm or more and 5.0 μm or less, and heights of the three ridges (a protruding height Ha from the first surface 24A) are preferably, for example, 0.1 μm or more and 1.0 μm or less.

Propagation can be performed in a single mode by setting the size of each of the optical-input-side waveguides 50Aa1 and 50Aa2, the optical-output-side waveguide 50Ab1, the optical-input-side waveguides 50Ba1 and 50Ab1, and the optical-output-side waveguide 50Bb1 to about the wavelength of laser light.

### <Multimode-Interference-Type Optical Coupling Part>

### (1) Multimode-Interference-Type Optical Coupling Part Having Trapezoidal Cross-Section

Both the multimode-interference-type optical coupling parts 50A and 50B shown in FIG. 1 are multimode-interference-type optical coupling parts having two inputs and one output.

The multimode-interference-type optical coupling part 50A is a coupling part configured to couple light propagating in the optical-input-side waveguide 50Aa1 and light propagating in the optical-input-side waveguide 50Aa2 and output the coupled light to the optical-output-side waveguide 50Ab1.

Also, the multimode-interference-type optical coupling part SOB is a coupling part configured to multiple light propagating in the optical-output-side waveguide 50Ab1 and light propagating in the optical-input-side waveguide 50Ba1 and output the coupled light to the optical-output-side waveguide 50Bb1.

The multimode-interference-type optical coupling part preferably has a trapezoidal shape with a cross-section cut in a direction perpendicular to the light propagation direction. Also, a tilt angle of this trapezoidal shape is preferably 40° to 85°.

This is because the width dimension margin of the multimode-interference-type optical coupling part is improved, the optimum multimode-interference-type optical coupling part width is increased, and processing is easy.

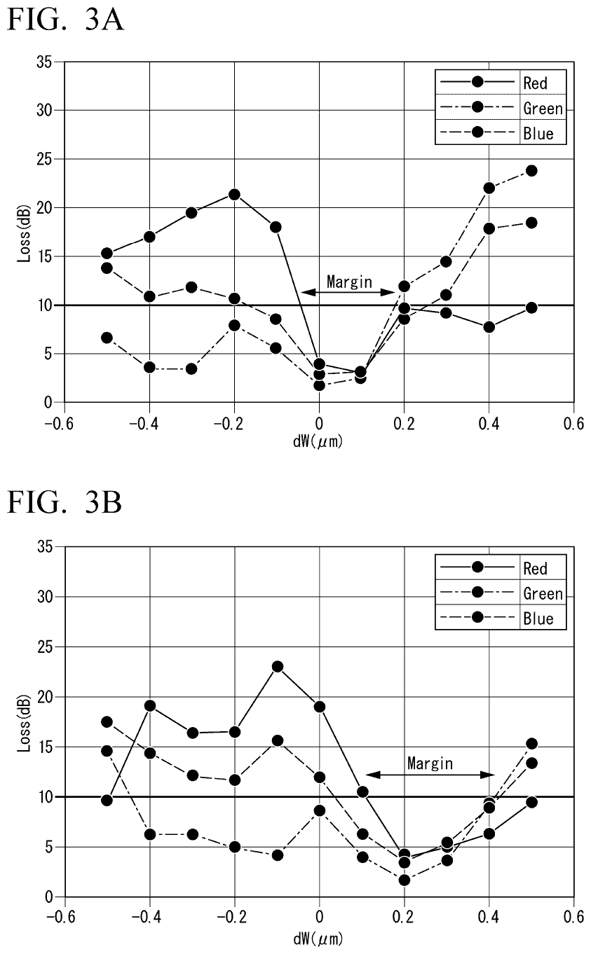

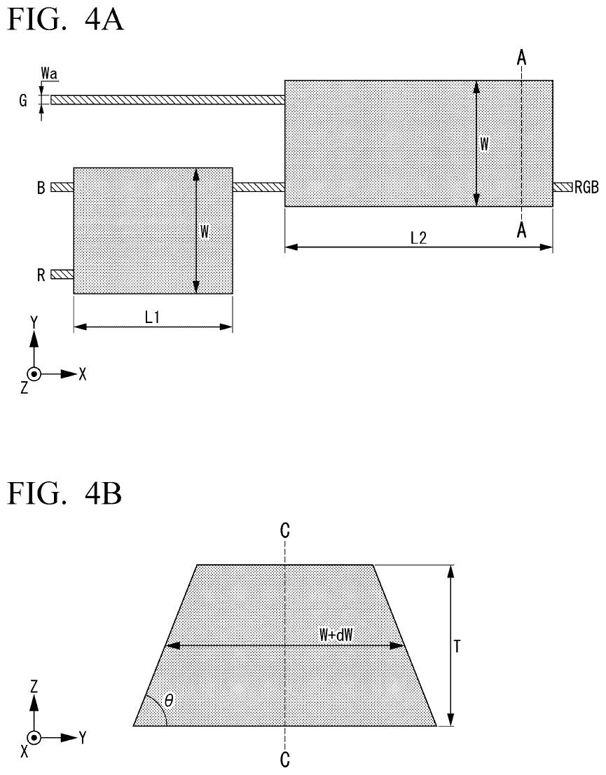

In FIGS. 3A and 3B, in the case where the cross-section of the multimode-interference-type optical coupling part that is cut in the direction perpendicular to the light travel direction is a trapezoidal shape and in the case where the cross-section is rectangular, graphs obtained by a simulation (Fimmwave manufactured by Photon Design) is shown in which the propagation losses of three RGB colors of light are compared. Also, FIGS. 4A and 4B show models used for the simulation.

As shown in FIG. 4A, an optical coupler having two stages of multimode-interference-type optical coupling parts each having two inputs and one output was used as a model as in FIG. 1. Also, as shown in FIG. 4B, the two stages of multimode-interference-type optical coupling parts had the same trapezoidal shape in a cross-section cut in the direction perpendicular to the light travel direction (a cross-section A-A in FIG. 4A) and were symmetrical with respect to a center line C-C of the upper surface and the lower surface thereof. In either one of the two stages of the multimode-interference-type optical coupling part, the height T was 0.7 μm, the length L1 of the first stage multimode-interference-type optical convergence unit was 620 μm, the length L2 of the second stage multimode-interference-type optical coupling part was 1680 μm, and the width W was 6.5 μm. Also, both the optical-input-side waveguide and the optical-output-side waveguide had a height T of 0.7 μm and a width Wa of 2 μm.

In this model, propagation loss during RGB coupling was simulated by setting a width at ½ of the height T of the multimode-interference-type optical coupling part (ridge) to W and widening or reducing both sides by dW/2 (accordingly, a total of dW) in a state in which a center line C-C of the ridge was fixed and a tilt angle θ between the lower surface and the tilted portion was fixed. In FIGS. 3A and 3B, the horizontal axis represents dW, the positive case is the case where the width was widened, and the negative case is the case where the width was reduced. The vertical axis represents propagation loss.

638 nm was used as the wavelength of red light (R), 520 nm was used as the wavelength of green light (G), and 473 nm was used as the wavelength of blue light (B).

Also, simulations were also performed for θ being 85°, 70°, 50°, and 40°.

Furthermore, as the comparison, simulations were performed as in the case where θ was 90° (rectangular shape).

FIG. 3A is a result of a case where θ was 90° (rectangular shape) and FIG. 3B is a result of a case where θ was 50°. dW was in the range of −0.5 μm to 0.5 μm (corresponding to the ridge width of 6.0 μm to 7.0 μm).

The range of dW at 10 dB or less in three RGB colors was evaluated as the margin of W.

From FIGS. 3A and 3B, the margins in the case where θ was 90° (rectangular shape) and in the case where θ was 50° were 0.2 μm and 0.3 μm, respectively. Also, from FIGS. 3A and 3B, dW when the propagation loss was lowest for the entire three RGB colors, i.e., the optimal width W, was 6.55 μm and 6.8 μm.

When θ was 85°, 70°, and 40°, the margins were all 0.3 μm and the optimal widths W were 6.6 μm, 6.6 μm, and 6.9 μm, respectively.

As described above, it was found that the width dimension margin was improved and processing is easy in the trapezoidal configuration as compared with the configuration in which the cross-section of the multimode-interference-type optical coupling part is rectangular.

Also, it was found that processing can be made easier by increasing the optimum width W because the optimum width W, which had the lowest propagation loss of the entire three RGB colors, increased as the tilt angle θ decreased.

### (2) Multimode-Interference-Type Optical Coupling Part Having Slab Portion

In the multimode-interference-type optical coupling part, a slab portion may be further provided on the substrate side.

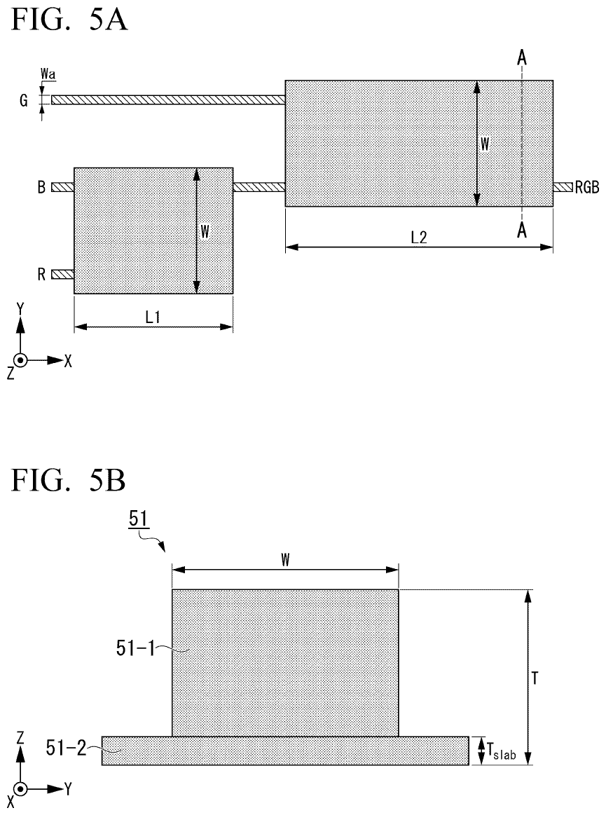

The multimode-interference-type optical coupling part 51 shown in FIG. 5B may further include a ridge 51-1 and a slab portion 51-2 further provided on the substrate side. In the case where the slab portion is provided, the width dimension margin can be further expanded and processing can be further facilitated. Also, the optimum width W can be further expanded and processing can be further facilitated.

Propagation losses (dB) of a single mode (TM0) and high-order modes (TM1 and TM2) of the three RGB colors during RGB coupling were simulated in the case where the multimode-interference-type optical coupling part had the model configuration shown in FIGS. 5A and 5B.

A height T_{slab} of the slab portion was set to 0.2 μm and a height T of the multimode-interference-type optical coupling part was set to a sum of the height of the ridge 51-1 and the height of the slab portion 51-2. The width W of the multimode-interference-type optical coupling part was set to 6.5 μm. Other dimensions were the same as those shown in FIGS. 4A and 4B. Table 1 shows resulting propagation loss values (dB). As a comparison, a numerical value obtained by subtracting corresponding light propagation loss when there is no slab portion from light propagation loss when there is no slab portion and light propagation loss when there is a slab portion is shown.

TABLE 1

| | | R | G | B |
|---|---|---|---|---|
| T_{slab} = 0 μm | TM0 | 4.11 | 1.77 | 3.02 |
| | TM1 | 19.29 | 19.00 | 30.12 |
| | TM2 | 17.91 | 17.56 | 19.59 |
| T_{slab} = 0.2 μm | TM0 | 3.25 | 2.07 | 2.97 |
| | TM1 | 23.11 | 18.15 | 34.44 |
| | TM2 | 20.21 | 16.65 | 19.68 |
| Difference between | TM0 | −0.86 | 0.3 | −0.06 |
| presence and absence | TM1 | 3.81 | −0.85 | 4.32 |
| of slab | TM2 | 2.30 | −0.91 | 0.09 |

In the case where the slab portion was present, a propagation loss difference was reduced in RGB as compared to the case where the slab portion was absent. Also, results indicating that the propagation loss of the TM0 mode was reduced for red light and blue light, the propagation loss of the high-order mode became large, and the propagation was suppressed were obtained from the propagation loss difference between the case where the slab portion was present and the case where the slab portion was absent.

Therefore, it was found that a process of providing a slab portion is effective for implementing the single mode.

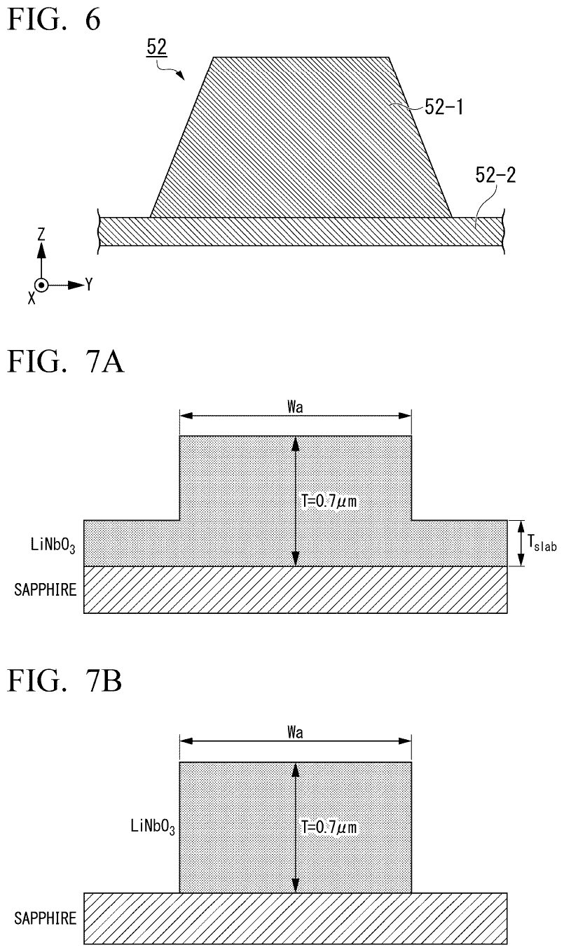

As shown in FIG. 6, the multimode-interference-type optical coupling part 52 having a trapezoidal cross-section may include a ridge 52-1 and a slab portion 52-2 further provided on the substrate side. By providing the slab portion, the width dimension margin can be further expanded and the optimum width W can be further expanded, such that processing is further facilitated. Also, the propagation loss in the TM0 mode can be reduced for red light and blue light and the propagation of the high-order mode can be suppressed.

### <Optical-Input-Side Waveguide and Optical-Output-Side Waveguide>

The optical-input-side waveguide and the optical-output-side waveguide connected to the multimode-interference-type optical waveguide are preferably single-mode optical waveguides. A single-mode optical waveguide refers to an optical waveguide in which propagation is performed when the light propagation mode is in a single state (a single mode) and an optical waveguide in a state (a high-order mode) in which propagation is distributed over a plurality of modes and performed is referred to as a multimode-based optical waveguide. Because the single mode does not cause mode dispersion, with regard to the single mode, the optical transmission loss is smaller and the propagation speed is faster than that in the multimode.

In at least a part of the optical-input-side waveguides and the optical-output-side waveguides, the slab portion is preferably provided on the substrate side.

This is because the width of the optical waveguide for RGB can be expanded to enable the implementation of the single mode.

FIGS. 7A and 7B show a linear optical waveguide composed of a lithium niobate (LiNbO₃) film formed on a sapphire substrate, and the height T of the optical waveguide is fixed at 0.7 μm, the thickness of the slab portion is T_{slab}, and the width of the ridge is Wa. FIG. 7A shows a case where there is a slab portion and FIG. 7B shows a case where there is no slab portion.

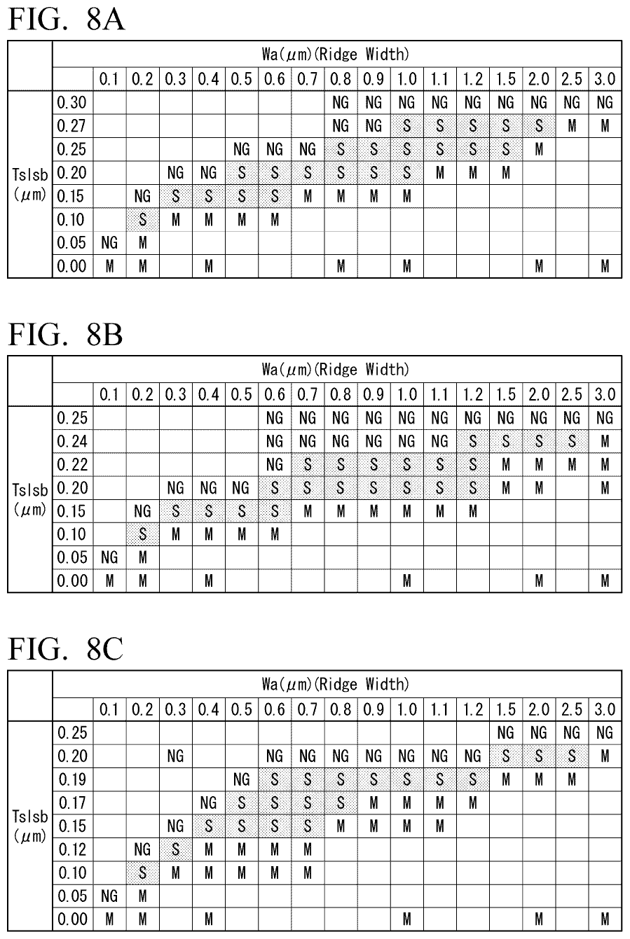

FIGS. 8A, 8B, and 8C show results of investigating the formation of a single mode by performing mode calculation when a thickness T_{slab} of the slab portion and a width Wa of the ridge were changed in the optical waveguide model shown in FIGS. 7A and 7B.

FIGS. 8A, 8B, and 8C show the results for red light (R) of 638 nm, the results for green light (G) of 520 nm, and the results for blue light (B) of 455 nm, respectively. In each matrix, S denotes the single mode, M denotes the multimode, and NG denotes that a single mode was a leaky mode.

Based on FIG. 8A, for red light (R) of 638 nm, the single mode could not be implemented even if the ridge width Wa was narrowed when the height of the optical waveguide T=0.7 μm and there was no slab portion (thickness T_{slab}=0 μm), but the single mode could be implemented according to the ridge width Wa when the thickness of the slab portion T_{slab}=0.10 μm if there was a slab portion and the single mode could be implemented until Wa=2.0 μm.

Based on FIG. 8B, for green light (G) of 520 nm, the single mode could not be implemented even if the ridge width Wa was narrowed when the height of the optical waveguide T=0.7 μm and there was no slab portion (thickness T_{slab}=0 μm), but the single mode could be implemented according to the ridge width Wa when the thickness of the slab portion T_{slab}=0.10 μm or more if there was a slab portion and the single mode could be implemented until Wa=2.5 μm.

Based on FIG. 8C, for blue light (G) of 455 nm, the single mode could not be implemented even if the ridge width Wa was narrowed when the height of the optical waveguide T=0.7 μm and there was no slab portion (thickness T_{slab}=0 μm), but the single mode could be implemented according to the ridge width Wa when the thickness of the slab portion T_{slab}=0.10 μm or more if there was a slab portion and the single mode could be implemented until Wa=2.5 μm.

In at least a part of the optical-input-side waveguides and the optical-output-side waveguides, a bending portion is preferably provided. This is because the high-order mode can be suppressed.

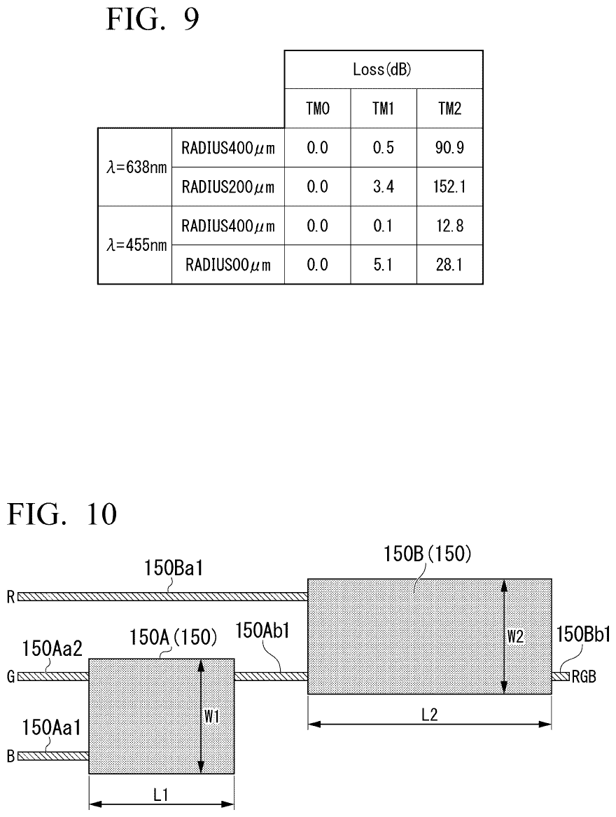

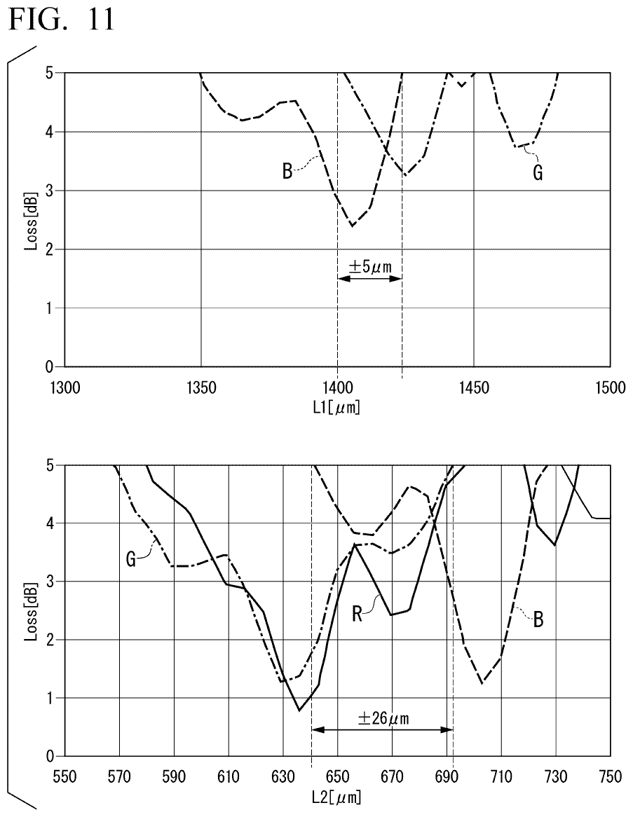

FIG. 9 shows results of investigating the suppression of a high-order mode when a bending portion is provided in a part of the optical waveguide which are a result of a case of red light (R) of 638 nm, and a result of a case of blue light (B) of 455 nm. From FIG. 9, in the model shown in FIGS. 7A and 7B, when the thickness of the slab portion was fixed at T_{slab}=0.15 μm, if a bending portion having a radius of curvature is 400 μm was provided for red light (R) of 638 nm, the single mode TM0 had a propagation loss of 0 dB, but losses of 0.5 dB and 90.9 dB occurred in the high-order modes TM1 and TM2, respectively, and propagation was suppressed. Furthermore, if a bending portion having a radius of curvature of 200 μm was provided, the single mode TM0 had a propagation loss of 0 dB, but losses of 3.4 dB and 152.1 dB occurred in the high-order modes TM1 and TM2, respectively, and propagation was significantly suppressed.

Likewise, from FIG. 9, when the thickness of the slab portion was fixed at T_{slab}=0.15 Jim, if a bending portion having a radius of curvature was 400 μm is provided for blue light (R) of 455 nm, the single mode TM0 had a loss of 0 dB, but losses of 0.1 dB and 12.8 dB occurred in the high-order modes TM1 and TM2, respectively, and propagation was suppressed. Furthermore, if a bending portion having a radius of curvature of 200 μm was provided, the single mode TM0 had a loss of 0 dB, but losses of 5.1 dB and 28.1 dB occurred in the high-order modes TM1 and TM2, respectively, and propagation was significantly suppressed.

For the optical coupler according to the present embodiment, in two optical-input-side waveguides and one optical-output-side waveguide connected to at least one of the one or more stages of multimode-interference-type optical coupling parts each having two inputs and one output, the two optical-input-side waveguides preferably have different widths and the one optical-output-side waveguide preferably has the same width as the optical-input-side waveguide having a narrower width between the two optical-input-side waveguides.

For example, in the RGB coupling configuration, input coupling loss can be reduced by setting the width of each optical-input-side waveguide to a maximum width for enabling the single mode to be maintained and the output light from the optical-output-side waveguide can also maintain the single mode. This effect can be confirmed by FIGS. 8A, 8B, and 8C illustrated as examples.

### <Order of Visible Light to be Coupled>

The optical coupler according to the present embodiment includes two or more stages of multimode-interference-type optical coupling parts. Preferably, a first-stage multimode-interference-type optical coupling part couples visible light of a wavelength A and visible light of a wavelength B and a second-stage multimode-interference-type optical coupling part couples light obtained by coupling the visible light of the wavelength A and the visible light of the wavelength B with visible light of a wavelength C.

This configuration enables RGB to be coupled in two stages.

Also, by adding third and subsequent stages of multimode-interference-type optical coupling parts to this configuration, it is possible to supplement the weak light intensity by adding light having a different wavelength (for example, a wavelength B′) and the like. In this example, the wavelength B′ is a wavelength identical to or close to the wavelength B and can reinforce the intensity of the color.

Also, in the configuration, preferably, the wavelength A is greater than the wavelength B and the wavelength A is greater than the wavelength C.

The wavelength A is, for example, red light (610 nm or more and 750 nm or less), either one of the wavelength B and the wavelength C is, for example, green light (500 nm or more and 560 nm or less), and the other is, for example, 435 nm or more and 480 nm or less.

By coupling visible light in this order, propagation loss due to RGB coupling can be reduced. Also, the length dimension margin of the multimode-interference-type optical coupling can be increased. This effect will be described below with reference to the examples and the comparative examples.

<Verification of Order of Visible Light to be Coupled (from Viewpoint of Propagation Loss and Margin of Length of Coupling Part)>

In Patent Document 3, an optical coupler has two stages of multimode-interference-type coupling parts (hereinafter referred to as an MMI coupling parts) configured to couple three wavelengths of visible light (three wavelengths λ2, and λ3 have a relationship of λ1<λ2<λ3 and a relationship of |λ1−λ2|<|λ2−λ3|), wherein the first-stage MMI coupling part (length L1) couples visible light of a wavelength λ1 and visible light of a wavelength λ2 and the second-stage MMI coupling part (length L2 (<L1)) couples the coupled visible light and visible light of a wavelength λ3 (see claim 1). Also, in Patent Document 3, blue light (460 nm light) as λ1, green light (510 nm light) as λ2, and red light (635 nm light) as λ3 are exemplified. In this case, |λ1−λ2|=50 nm and |λ2−λ3|=125 nm. As described in the optical coupler disclosed in Patent Document 3, there are relationships between the three wavelengths λ1, λ2, and λ3 and a relationship between the lengths of the two stages of the MMI coupling parts; and thereby, a single mode can be obtained with an output of 65% to 75% for all blue light, green light, and red light (see the paragraph 0038 and FIGS. 3A and 3B).

### Comparative Example 1

In the optical coupling part shown in FIG. 10, for the order of visible light to be coupled and the length of the two stages of MMI coupling parts, simulation of the propagation loss during coupling was performed in accordance with Patent Document 3. 638 nm was used as the wavelength of red light (R), 520 nm was used as the wavelength of green light (G), and 473 nm was used as the wavelength of blue light (B). The two stages of the MMI couplers 150A (150) and 150B (150) were all MMI coupling parts having rectangular cross-sections and had slab portions. The thicknesses of the slab portions were 0.2 μm, the widths W thereof were 6 μm, and the heights T thereof were 0.7 μm, the length L1 of the MMI coupling part 150A was 1420 μm, and the length L2 of the MMI coupling part 150B was 670 μm. Also, the optical-input-side waveguides 150Aa1 and 150Aa2, the optical-output-side waveguide 150Ab1, the optical-input-side waveguides 150Ba1 and 150Ab1, and the optical-output-side waveguide 150Bb1 all had a height T of 0.7 μm and a width of 2 μm.

FIG. 11 shows simulation results of propagation loss during coupling.

The upper graph of FIG. 11 shows propagation loss during GB coupling when the length L1 of the MMI coupling part 150A was changed by adding about 100 μm to 1420 μm or reducing about 100 μm from 1420 μm and the lower graph thereof shows propagation loss during RGB coupling when the length L2 of the MMI coupling part 150B was changed by adding about 100 μm to 670 μm or reducing about 100 μm from 670 μm.

The minimum propagation losses of G and B during GB coupling was about 3.8 dB when L1 were 1420 μm, and the minimum propagation losses of R, G, and B during RGB coupling were about 2.4 dB, 3.5 dB, and 4.2 dB, respectively, when L2 was 670 μm.

When the propagation loss was set to 5 dB or less for any light, the margin of L2 was about ±26 μm which was large, but the margin of L1 was about ±5 μm which was significantly narrow.

### Example 1

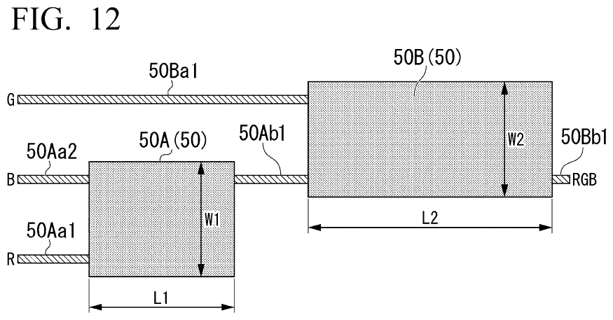

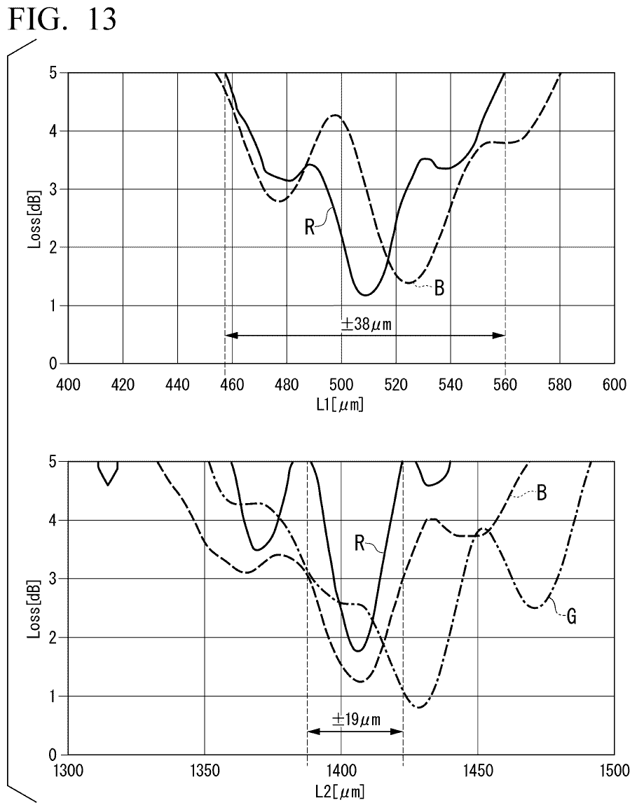

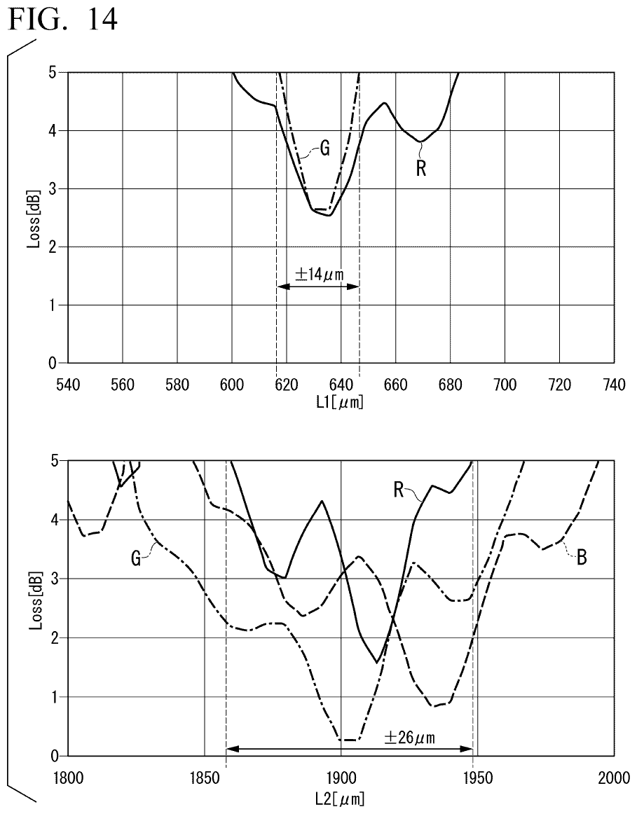

Next, in the optical coupler shown in FIG. 12, the order of visible light to be coupled and the lengths of two stages of MMI coupling parts were changed and the propagation loss during the coupling was simulated. A simulation process was performed in the same manner as that in Comparative Example 1, except that red light (R) and blue light (B) were coupled in the first-stage MMI coupling part 50A, the coupled light and green light (G) were coupled in the second-stage MMI coupling part 50B, the length L1 of the MMI coupling part 50A was 520 μm, and the length L2 of the MMI coupling part SOB was 1400 μm.

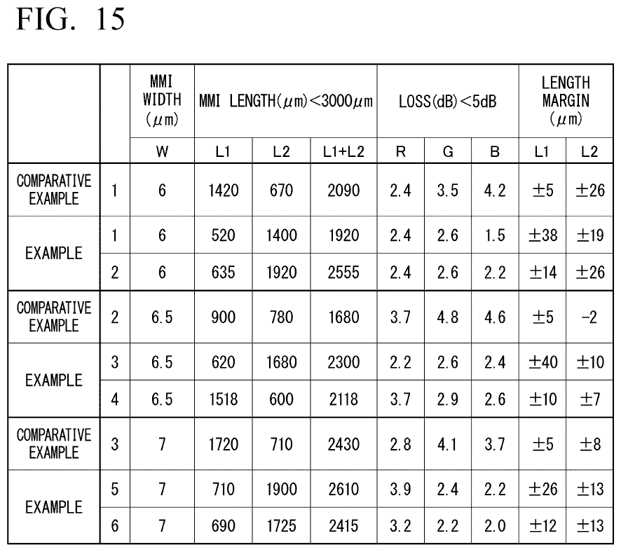

FIG. 13 shows simulation results of propagation loss during coupling.

The upper graph of FIG. 13 shows propagation loss during RB coupling when the length L1 of the MMI coupling part 50A was changed by adding about 100 μm to 520 μm or reducing about 100 μm from 520 μm and the lower graph thereof shows propagation loss during RGB coupling when the length L2 of the MMI coupling part 50B was changed by adding about 100 μm to 1400 μm or reducing about 100 μm from 1400 μm.

The minimum propagation losses of R and B during RB coupling were about 2.2 dB and 1.6 dB, respectively, when L1 was 520 μm, the minimum propagation losses of R, G, and B during RGB coupling were about 2.4 dB, 2.6 dB, and 1.5 dB, respectively, when L2 was 1400 lam, and the propagation loss lowered as compared with the case of the optical coupler shown in FIG. 10.

Also, when the propagation loss was set to 5 dB or less for any light, the margin of L2 was about ±19 μm slightly smaller than that of Comparative Example 1, but the margin of L1 was about ±38 μm and significantly expanded as compared with Comparative Example 1.

### Example 2

Next, in the optical coupler shown in FIG. 12, the order of visible light to be coupled and the lengths of two stages of MMI coupling parts were changed and the propagation loss during the coupling was simulated. A simulation process was performed in the same manner as that in Comparative Example 1, except that red light (R) and blue light (B) were coupled in the first-stage MMI coupling part 50A, the coupled light and green light (G) were subsequently coupled in the second-stage MMI coupling part 50B, the length L1 of the MMI coupling part 50A was 635 μm, and the length L2 of the MMI coupling part 50B was 1920 μm.

FIG. 14 shows simulation results of propagation loss during coupling.

The upper graph of FIG. 14 shows propagation loss during RG coupling when the length L1 of the MMI coupling part 50A was changed by adding about 100 μm to 635 μm or reducing about 100 μm from 635 μm, and the lower graph thereof shows propagation loss during RGB coupling when the length L2 of the MMI coupling part 50B was changed by adding about 100 μm to 1920 μm or reducing about 100 μm from 1920 μm.

The minimum propagation losses of R and G during RG coupling were about 2.6 dB and 2.7 dB, respectively, when L1 was 635 μm, and the minimum propagation losses of R, G, and B during RGB coupling were about 2.4 dB, 2.6 dB, and 2.2 dB, respectively, when L2 was 1920 μm and the propagation loss lowered as compared with Comparative Example 1.

Also, when the propagation loss was set to 5 dB or less for any light, the margin of L2 was about ±26 μm, which was the same as that of the optical coupling part shown in FIG. 10, but the margin of L1 was about ±14 μm and significantly expanded as compared with Comparative Example 1.

### Comparative Example 2 and Examples 3 and 4

Comparative Example 2 and Examples 3 and 4 were commonly different from Comparative Example 1 in that the widths W of the two stages of the MMI coupling parts were 6.5 μm.

Furthermore, in Comparative Example 2, propagation loss during coupling was simulated in the same manner as that in Comparative Example 1, except that the length L1 of the first-stage MMI coupling part was 900 μm and the length L2 of the second-stage MMI coupling part was 780 μm.

In Example 3, propagation loss during coupling was simulated in the same manner as that in Example 1, except that the length L1 of the first-stage MMI coupling part was 620 μm and the length L2 of the second-stage MMI coupling part was 1680 μm. In Example 4, propagation loss during coupling was simulated in the same manner as that in Example 2, except that the length L1 of the first-stage MMI coupling part was 1518 μm and the length L2 of the second-stage MMI coupling part was 600 μm.

FIG. 15 shows simulation results of Examples 1 to 6 and Comparative Examples 1 to 3.

The propagation loss shown in FIG. 15 is that during RGB coupling.

In Comparative Example 2, the minimum propagation losses of G and B during GB coupling were about 4.8 dB when L1 was 900 μm. In Comparative Example 2, the length margin of L2 was only on the negative side.

In Example 3, both minimum propagation losses of R and B during RB coupling were about 2.2 dB when L1 was 620 μm.

In Example 4, the minimum propagation losses of R and G during RG coupling were about 3.3 dB and 2.8 dB, respectively, when L1 was 1518 μm.

In Example 3, the propagation loss was lower in all RGB than in Comparative Example 2 and the length margin was wider for both L1 and L2 than in Comparative Example 2.

In Example 4, the propagation loss was lower in GB than in Comparative Example 2 and the length margin was wider for both L1 and L2 than in Comparative Example 2.

### Comparative Examples 3 and Examples 5 and 6

Comparative Examples 3 and Examples 5 and 6 were different from the other comparative examples in that the widths W of the two stages of the MMI coupling parts were 7 μm.

Furthermore, in Comparative Example 3, propagation loss during coupling was simulated in the same manner as that in Comparative Example 1, except that the length L1 of the first-stage MMI coupling part was 1720 μm and the length L2 of the second-stage MMI coupling part was 710 μm.

In Example 5, propagation loss during coupling was simulated in the same manner as that in Example 1, except that the length L1 of the first-stage MMI coupling part was 710 μm and the length L2 of the second-stage MMI coupling part was 1900 μm. In Example 6, propagation loss during coupling was simulated in the same manner as that in Example 2, except that the length L1 of the first-stage MMI coupling part was 690 μm and the length L2 of the second-stage MMI coupling part was 1725 μm.

In Comparative Example 3, the minimum propagation losses of G and B during GB coupling were about 4.0 dB and 3.8 dB, respectively, when L1 was 1720 μm.

In Example 5, the minimum propagation losses of R and B during RB coupling were about 3.8 dB and 2.1 dB, respectively, when L1 was 710 μm.

In Example 6, the minimum propagation losses of R and G during RG coupling were about 3.2 dB and 2.2 dB, respectively, when L1 was 690 μm.

In Example 5, the propagation loss was lower in GB than that in Comparative Example 3 and the length margin was wider for both L1 and L2 than in Comparative Example 2.

In Example 6, the propagation loss was lower in GB than that in Comparative Example 3 and the length margin was wider for both L1 and L2 than that in Comparative Example 2.

In the above comparative examples and examples, even if there is no slab portion in the MMI coupling part, relationships between the comparative examples and the examples of the propagation loss of each RGB color, the L1 margin, and the L2 margin tend to be identical to those of the case where there is a slab portion.

### [Visible Light Source Module]

### First Embodiment

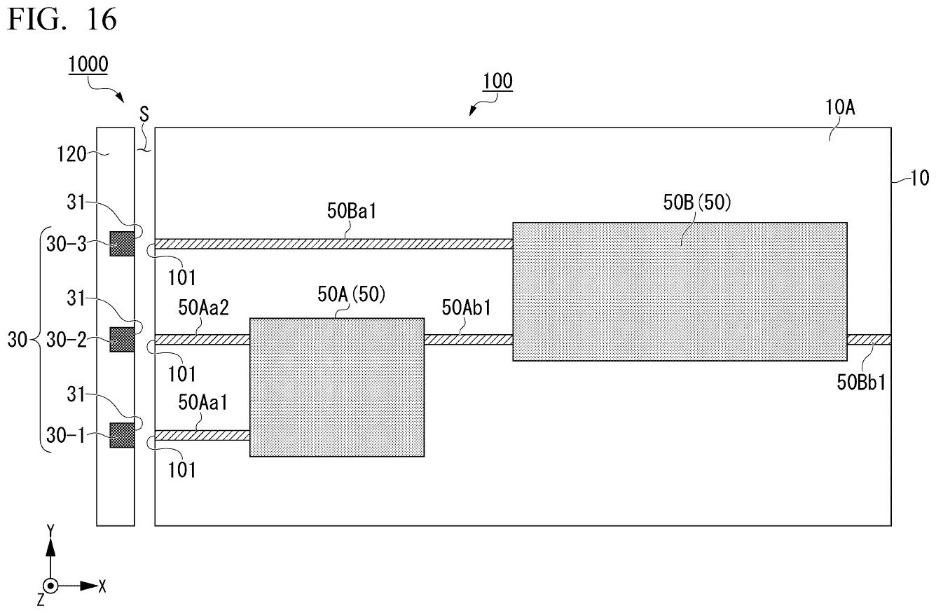

FIG. 16 is a schematic plan view of the visible light source module according to the first embodiment.

A visible light source module 1000 shown in FIG. 16 includes the above-described optical coupler 100 and a plurality of visible laser light sources 30 (30-1, 30-2, and 30-3) configured to output visible light to be coupled by the optical coupler 100.

Components shown in FIG. 16 similar to those of the above-described components are denoted by the same reference signs and descriptions thereof may be omitted.

As the visible laser light source 30, various types of laser elements can be used. For example, commercially available laser diodes (LD) such as red light, green light, and blue light can be used. Light having a peak wavelength of 610 nm or more and 750 nm or less can be used as red light, light having a peak wavelength of 500 nm or more and 560 nm or less can be used as green light, and light having a peak wavelength of 435 nm or more and 480 nm or less can be used as blue light.

In the visible light source module 1000, the visible laser light sources 30-1, 30-2, and 30-3 are an LD that emits red light, an LD that emits blue light, and an LD that emits green light, respectively. The LDs 30-1, 30-2, and 30-3 are arranged at intervals in a direction substantially orthogonal to an output direction of light emitted from each LD and are provided on the upper surface of the subcarrier 120.

Although a case where the number of visible laser light sources is three has been illustrated in the visible light source module 1000, the number of visible laser light sources is not limited to three and it is only necessary for the number of visible laser light sources to be a plural such as two, four, or more. A plurality of visible laser light sources may all emit light beams having different wavelengths or may emit light beams having the same wavelength. Also, light other than red (R), green (G), and blue (B) can be used as the light to be emitted and the mounting order of red (R), green (G), and blue (B) described using the drawings does not need to be in that order and can be appropriately changed.

The LD 30 can be mounted on the subcarrier 120 with a bare chip. The subcarrier 120 is composed of, for example, aluminum nitride (AlN), aluminum oxide (Al₂O₃), silicon (Si), and the like.

The subcarrier 120 can have a configuration in which the subcarrier 120 is directly bonded to the substrate 10 via a metallic layer. This configuration enables further miniaturization without performing spatial coupling or fiber coupling.

A light output surface 31 of the LD 30 and a light input surface 101 of the optical coupler 100 are arranged at predetermined intervals. The light input surface 101 faces the light output surface 31 and there is a gap S between the light output surface 31 and the light input surface 101 in the x-direction. Because the visible light source module 1000 is exposed to the air, the gap S is filled with air. Because the gap S is filled with the same gas (air), it is easy to input light of each color emitted from the LD 30 to an input path in a state where prescribed coupling efficiency is satisfied. In the case where the visible light source module 1000 is used for AR glasses and VR glasses, a size of the gap (interval) S in the x-direction is, for example, larger than 0 μm and less than or equal to 5 μm, based on a light intensity required for the AR glasses and VR glasses or the like.

### Second Embodiment

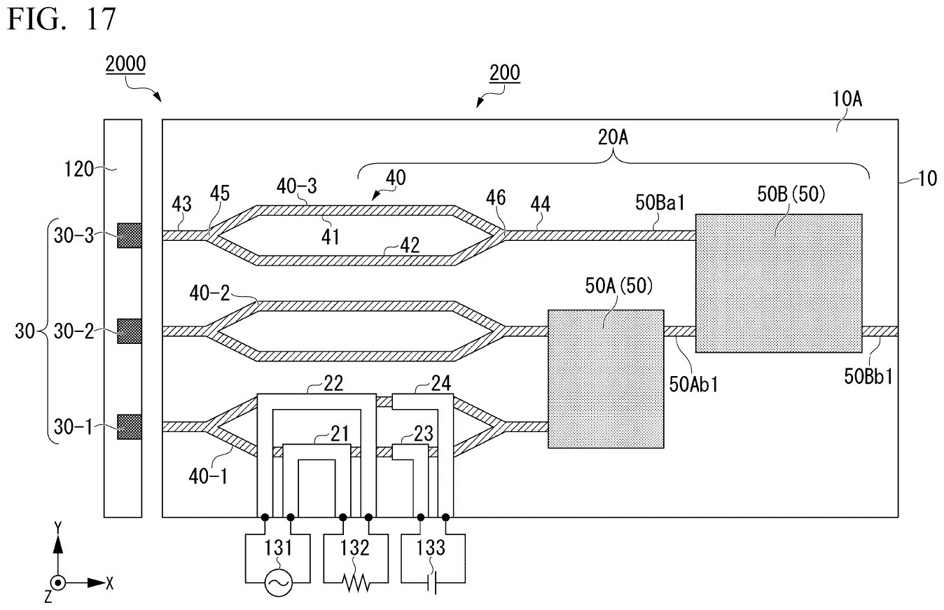

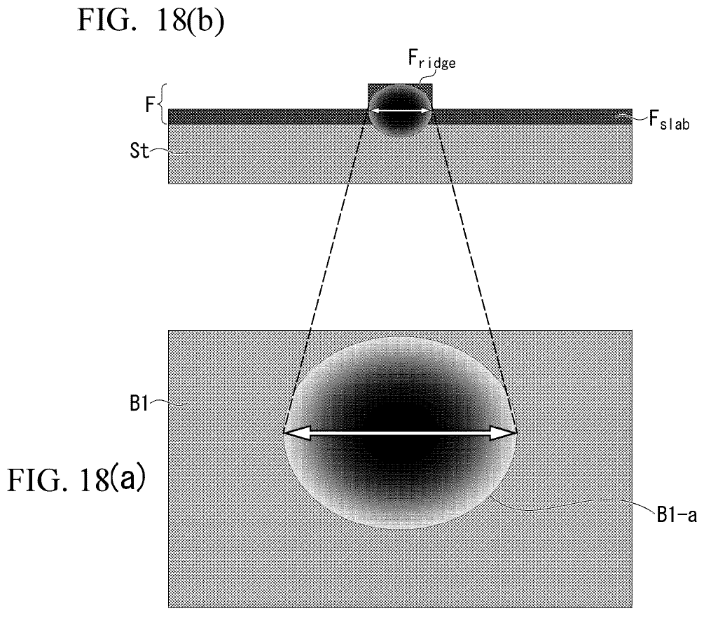

FIG. 17 is a schematic plan view of a visible light source module according to a second embodiment.

A visible light source module 2000 shown in FIG. 17 includes an optical coupler 200 with an optical modulation function and a plurality of visible laser light sources 30 (30-1, 30-2, and 30-3) that output visible light coupled by the optical coupler 200 with the optical modulation function.

Components shown in FIG. 17 similar to those of the above-described components are denoted by the same reference signs and descriptions thereof may be omitted.

The optical coupler 200 with the optical modulation function includes a substrate made of a material different from lithium niobate; and an optical coupling function layer 20A formed on a main surface 10A of the substrate 10 and including a Mach-Zehnder-type optical modulator 40, wherein the optical coupling function layer 20A includes two multimode-interference-type optical coupling parts 50 (50A and 50B), optical-input-side waveguides 50Aa1 and 50Aa2 and an optical-output-side waveguide 50Ab1 which are connected to the multimode-interference-type optical coupling part 50A, and optical-input-side waveguides 50Ba1 and 50Ab1 and an optical-output-side waveguide 50Bb1 which are connected to the multimode-interference-type optical coupling part 50B in addition to the Mach-Zehnder-type optical modulator 40, and wherein the Mach-Zehnder-type optical modulator 40, the multimode-interference-type optical coupling part 50, the optical-input-side waveguides 50Aa1 and 50Aa2, the optical-output-side waveguide 50Ab1, the optical-input-side waveguides 50Ba1 and 50Ab1, and the optical-output-side waveguide 50Bb1 are made of a lithium niobate film.

As the Mach-Zehnder-type optical modulator 40, a known Mach-Zehnder-type optical modulator or optical waveguide can be used, a light beam consistent in the wavelength and phase is divided (decoupled) into two pairs of beams, and different phases are assigned to the beams, and the beams with the different phases merge (or are coupled). According to a difference between phase differences, an intensity of a beam of the coupled light changes.

The Mach-Zehnder-type optical modulator 40 includes three Mach-Zehnder-type optical waveguides 40-1, 40-2, and 40-3 equal in number to the visible light laser sources 30-1, 30-2, and 30-3. The visible light laser sources 30-1, 30-2, and 30-3 and the Mach-Zehnder optical waveguides 40-1, 40-2, and 40-3 are positioned so that the light emitted from the visible laser light source is input to the corresponding Mach-Zehnder-type optical waveguide.

The Mach-Zehnder-type optical waveguides 40-1, 40-2, and 40-3 shown in FIG. 17 include a first optical waveguide 41, a second optical waveguide 42, an input path 43, an output path 44, a branch portion 45, and a coupling portion 46. The output path 44 is an optical-input-side waveguide of the multimode-interference-type optical coupling part. The first optical waveguide 41 and the second optical waveguide 42 shown in FIG. 17 have a configuration that linearly extends in the x-direction except for a region surrounding the branch portion 45 and a region surrounding the coupling portion 46, but the present invention is not limited to such a configuration. The lengths of the first optical waveguide 41 and the second optical waveguide 42 shown in FIG. 17 are substantially the same. The branch portion 45 is between the input path 43 and the first optical waveguide 41 and the second optical waveguide 42. The input path 43 is connected to the first optical waveguide 41 and the second optical waveguide 42 via the branch portion 45. The coupling portion 46 is located between the first optical waveguide 41 and the second optical waveguide 42 and the output path 44. The first optical waveguide 41 and the second optical waveguide 42 are connected to the output path 44 via the coupling portion 46.

Electrodes 21 and 22 are electrodes for applying a modulation voltage to the Mach-Zehnder-type optical waveguides 40-1, 40-2, and 40-3 (hereinafter simply referred to as “Mach-Zehnder-type optical waveguides 40”). The electrode 21 is an example of a first electrode and the electrode 22 is an example of a second electrode. One end of the electrode 21 is connected to a power supply 131 and the other end is connected to a termination resistor 132.

One end of the electrode 22 is connected to the power supply 131 and the other end is connected to the termination resistor 132. The power supply 131 is part of a drive circuit that applies a modulation voltage to each Mach-Zehnder-type optical waveguide 40. For the sake of simplifying the drawing, the electrodes 21 and 22 are shown only on a portion of the Mach-Zehnder-type optical waveguide 40-1.

Electrodes 23 and 24 are electrodes that apply a DC bias voltage to each Mach-Zehnder-type optical waveguide 40. One end of the electrode 23 and one end of the electrode 24 are connected to the power supply 133. The power supply 133 is a part of a DC bias application circuit that applies a DC bias voltage to each Mach-Zehnder optical waveguide 40.

When the DC bias voltage is superimposed on the electrodes 21 and 22, the electrodes 23 and 24 may not be provided. Also, a ground electrode may be provided around the electrodes 21, 22, 23, and 24.

A size of the optical coupling function layer 20A is, for example, 100 mm² or less. If the size of the optical coupling function layer 20A is 100 mm² or less, it is suitable for AR glasses and VR glasses.

The optical coupling function layer 20A can be produced by a known method. For example, the optical coupling function layer 20A is manufactured using semiconductor processes such as epitaxial growth, photolithography, etching, vapor deposition, and metallization.

For example, in order to display an image with a desired color in a retina-projection-type display, it is necessary to independently modulate the intensity of each of the three RGB colors representing visible light at a high speed. Although the load on the IC that controls the modulation increases when such modulation is performed only by the visible laser light source (electric current modulation), a modulation (voltage modulation) process of the Mach-Zehnder-type optical modulator 40 (the optical coupler 200 with the optical modulation function) can also be used. In this case, a rough adjustment process may be performed with a current (a visible laser light source) and a fine adjustment process may be performed with a voltage (the Mach-Zehnder-type optical modulator 40), or a rough adjustment process may be performed with a voltage (the Mach-Zehnder-type optical modulator 40) and a fine adjustment process may be performed with a current (a visible laser light source). Because a method in which the fine adjustment process for the voltage is performed has good responsiveness, it is preferable to adopt the former when importance is put on responsiveness. Because a method in which the fine adjustment process for the current is performed is completed with a small current and enables power consumption to be suppressed, it is preferable to adopt the latter when importance is put on the suppression of the power consumption.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10 Substrate
10A Substrate surface
20, 20A Optical coupling function layer
24 Waveguide core film
25 Waveguide cladding film
30 Visible laser light source
50Aa1, 50Aa2, 50Ba1 Optical-input-side waveguide
50Bb1 Optical-output-side waveguide
50, 51, 52 Multimode-interference-type optical coupling part
51-1, 52-1 Ridge
51-2, 52-2 Slab portion
100 Optical coupler
200 Optical coupler with optical modulation function
1000, 2000 Visible light source module

What is claimed is:

1. An optical coupler for coupling a plurality of visible light beams having different wavelengths, the optical coupler comprising:
a substrate made of a material different from lithium niobate; and
an optical coupling function layer formed on a main surface of the substrate,
wherein the optical coupling function layer includes: one or more stages of multimode-interference-type optical coupling parts; and optical-input-side waveguides and optical-output-side waveguides which are connected to the one or more stages of multimode-interference-type optical coupling parts, and
wherein the multimode-interference-type optical coupling parts, the optical-input-side waveguides, and the optical-output-side waveguides are made of a lithium niobate film.

2. The optical coupler according to claim 1, wherein any one of the one or more stages of multimode-interference-type optical coupling parts is a multimode-interference-type optical coupling part having two inputs and one output.

3. The optical coupler according to claim 1, wherein at least one of the one or more stages of multimode-interference-type optical coupling parts has a trapezoidal shape in a cross-section cut in a direction perpendicular to a light travel direction.

4. The optical coupler according to claim 3, wherein a tilt angle of the trapezoidal shape is 40° to 85°.

5. The optical coupler according to claim 3, wherein the multimode-interference-type optical coupling part having the cross-section of the trapezoidal shape has a slab portion on a substrate side.

6. The optical coupler according to claim 1, wherein a slab portion is provided in at least a part of the optical-input-side waveguides and the optical-output-side waveguides.

7. The optical coupler according to claim 1, wherein a bending portion is provided in at least a part of the optical-input-side waveguides and the optical-output-side waveguides.

8. The optical coupler according to claim 2, wherein, in two optical-input-side waveguides and one optical-output-side waveguide connected to the multimode-interference-type optical coupling part of at least one of the one or more stages of multimode-interference-type optical coupling parts, the two optical-input-side waveguides have different widths and the one optical-output-side waveguide has the same width as the optical-input-side waveguide having a narrower width between the two optical-input-side waveguides.

9. The optical coupler according to claim 2, comprising two or more stages of multimode-interference-type optical coupling parts,
wherein a first-stage multimode-interference-type optical coupling part couples visible light of a wavelength A and visible light of a wavelength B and a second-stage multimode-interference-type optical coupling part couples light obtained by coupling the visible light of the wavelength A and the visible light of the wavelength B with visible light of a wavelength C.

10. The optical coupler according to claim 9, wherein the wavelength A is greater than the wavelength B and the wavelength A is greater than the wavelength C.

11. A visible light source module comprising:
the optical coupler according to claim 1; and
a plurality of visible laser light sources configured to output visible light coupled by the optical coupler.

12. An optical coupler with an optical modulation function comprising:
the optical coupler according to claim 1; and
a Mach-Zehnder-type optical modulator connected to the optical coupler and configured to guide a plurality of visible light beams output from a plurality of visible laser light sources to the optical coupler.

13. A visible light source module comprising:
the optical coupler with the optical modulation function according to claim 12; and
a plurality of visible laser light sources configured to output visible light to be coupled by the optical coupler with the optical modulation function.
